(19) United States
(12) Patent Application Publication
(10) Pub. No.: US 2007/0164992 A1
(43) Pub. Date: Jul. 19, 2007

(54) PORTABLE COMPUTING DEVICE FOR CONTROLLING A COMPUTER

(75) Inventors: Robert Han Liu, Shenzhen (CN); Kuan-Hong Hsieh, Shenzhen (CN); Xiao-Guang Li, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,293

(22) Filed: Dec. 27, 2006

(30) Foreign Application Priority Data
Jan. 17, 2006 (CN) 200610033249.8

(51) Int. Cl. G09G 5/00

(52) U.S. Cl. 345/156

(57) ABSTRACT

A portable computing device for controlling a computer is provided. The portable computing device includes an input device, and an optical sensing module. The optic sensing module is for capturing images which map a movement of the portable computing device. When the portable computing device is connected to the computer and is in a mouse mode, the optical sensing module is operative to serve as an input device for the computer to control a movement of a cursor thereon, and the input device is also operative to serve as an input device for the computer.

### BACKGROUND

1. Technical Field

The present invention relates to portable computing devices, and particularly to a portable computing device for controlling a computer.

2. General Background

Notebook computers commonly adopt a touchpad as an input device to control a cursor on a screen. The touchpad exempts additionally bringing a computer mouse when transporting/carrying the notebook computer. However, the touchpad is not an efficient input device, creating more work when used, hence the computer mouse is still desired when controlling the cursor on a screen. In most cases, an additional small wireless computer mouse is used as the input device. The additional small wireless computer mouse is also not an efficient input device, because the wireless computer mouse has signal delays that negatively affect the efficiency. The signal delays are often not within an acceptable range when the wireless mouse is used for, e.g., playing real-time games.

Nowadays, with cheap accessibility to other technological gadgets, people who likes listening to music via a portable media player would further bring along the portable media player when transporting the notebook computers. It is inconvenient to carry the notebook, the mouse, and the portable media player together.

What is needed, therefore, is a portable computing device for controlling a computer to overcome the above-described problem.

### SUMMARY

A portable computing device for controlling a computer is provided. The device includes a screen, an interface, an optical sensing module, and a microcontroller. The interface is configured for communicating with the computer. The optical sensing module is for capturing images that map a movement of the portable computing device. The microcontroller is electrically connected to the screen, the interface, and the optical sensing module. When detecting the interface is connected to the computer, the microcontroller displays a menu including a mouse mode item on the screen. When receiving an operational input corresponding to the mouse mode item, the microcontroller controls the portable computing device to enter a mouse mode. During the mouse mode, the microcontroller controls the optical sensing module to serve as an input unit for the computer to control a movement of a cursor of the computer.

Other advantages and novel features will be drawn from the following detailed description with reference to the attached drawing, in which:

### BRIEF DESCRIPTION OF THE DRAWINGS

FIG. 1 is an application schematic diagram of a portable computing device for controlling a computer in accordance with a preferred embodiment of the present invention;

FIG. 2 is a schematic diagram of a hardware infrastructure of the portable computing device of FIG. 1 connecting with the computer;

FIG. 3 is a flowchart of a preferred method for enabling the portable computing device of FIG. 2 to enter a particular mode;

FIG. 4 is a flowchart of a preferred method for controlling a menu displayed on the portable computing device of FIG. 2 in a device mode;

FIG. 5 is a flowchart of a preferred method for controlling the computer by utilizing the portable computing device of FIG. 2 in a mouse mode; and

FIG. 6 is a flowchart of a preferred method for generating a move operation for either FIG. 4 or FIG. 5.

### DETAILED DESCRIPTION OF THE EMBODIMENT

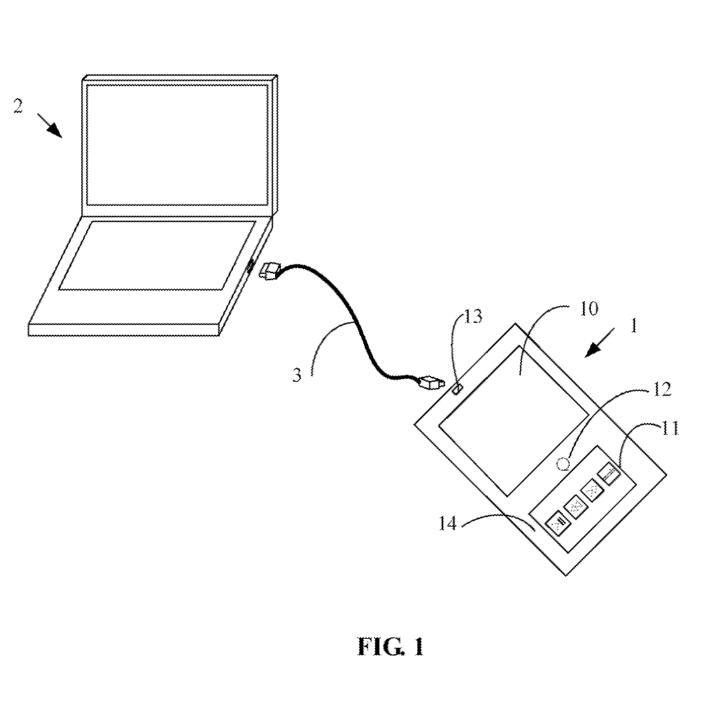

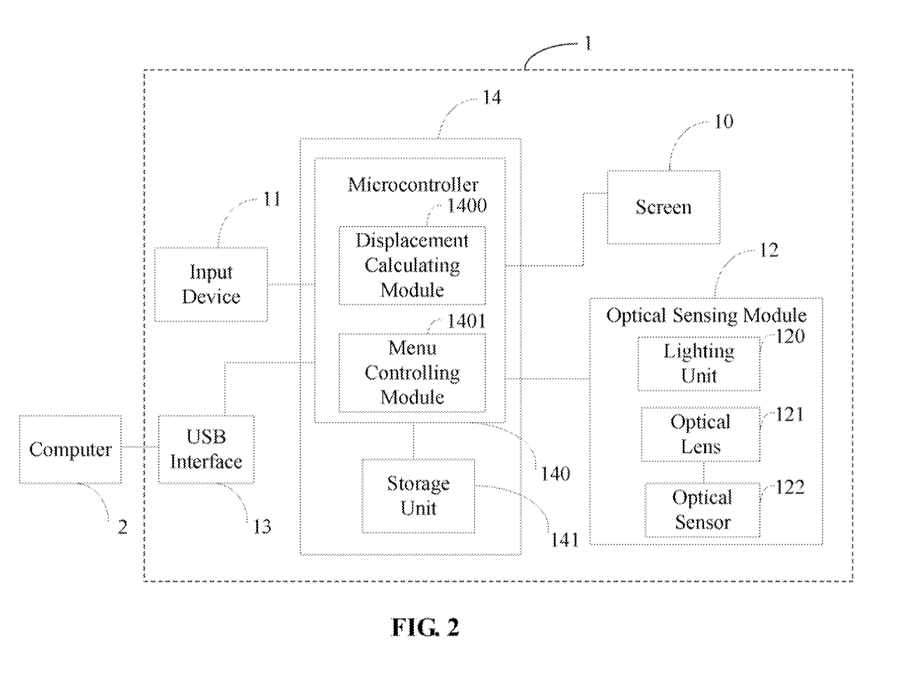

Referring to FIGS. 1 and 2, a portable computing device capable of controlling a computer in accordance with a preferred embodiment of the present invention is depicted. The portable computing device 1 can be connected to the computer through a wired connection or a wireless connection, and furthermore, can be used as a mouse of the computer. FIG. 1 shows an example of the portable computing device 1 connected to the computer 2 through a cable 3 (wired connection). The portable computing device 1 includes a screen 10, an input device 11, an optical sensing module 12, an interface 13, and a main body 14.

The input device 11 is configured for receiving an operational input and generating a control signal corresponding to the operational input. The interface 13 is configured for communicating with an external electronic device, such as the computer 2. The interface 13 can be any appropriated form of media. For example, in the embodiment as shown in FIG. 2, the interface 13 is a USB interface.

The optical sensing module 12 is configured for capturing images that map a movement of the portable computing device 1. The optical sensing module 12, which is configured at the back of the screen 10, includes a lighting unit 120, an optical lens 121, and an optical sensor 122. The lighting unit 120 may be of any appropriate type of luminous body, such as a light emitting diode (LED), a laser diode, and the like. The lighting unit 120 is configured for emitting light to illuminate a surface upon which the portable computing device 1 rests. The optical lens 121 is configured for focusing reflected light generated on the surface and projecting the reflected light on the optical sensor. The optical sensor 122 is configured for periodically capturing images of the reflected light and transmitting information of the images captured to the main body 14.

The main body 14 includes a microcontroller 140 and a storage unit 141. The storage unit 141 is configured for storing information, and the information includes input mappings for the operational input on the input device 11. The microcontroller 140 is electrically connected to the storage unit 141, the screen 10, the input device 11, the optical sensing module 12, and the interface 13. When the microcontroller 140 detects that the interface 13 is connected to the computer 2, the microcontroller 140 displays a mode menu on the screen. The mode menu consists of a mouse mode item and a device mode item. When the portable computing device 1 receives an operational input selecting the mouse mode item, the microcontroller 140 is configured to control the portable computing device 1 to enter a mouse mode, thus, the portable computing device 1 is adopted as a mouse (pointing device) of the computer 2. When either the portable computing device 1 receives an operational input selecting the device mode item or the portable computing device 1 does not receive any operational input for the mode items in a predetermined time period, the microcontroller 140 is configured to control the portable computing device 1 to enter a device mode, thus, the portable computing device 2 is operated as an independent electronic device.

In the mouse mode, the microcontroller 140 controls the optical sensing module 12 to serve as an input device for the computer 2 to control a movement of a cursor of the computer 2. That is, the microcontroller 140 compares the information of a current image with that of a previous image from the optical sensing module 12 to obtain a displacement of the movement of the portable computing device 2, generates a signal according to the displacement of the movement of the portable computing device 2, and transmits the signal generated to the computer 2 through the interface 13, thereby enabling the computer 2 to control the cursor thereof to move a corresponding displacement.

Furthermore, in the mouse mode, the microcontroller 140 translates the control signal from the input device 11 into a control instruction according to the input mappings, and transmits the control instruction to the computer 2 for performing a corresponding operation through the interface 13.

For example, a portable media player (as shown in FIG. 1) representing the portable computing device 1 adopts buttons as the input device 11, wherein the buttons includes, but not limited thereto, a play/pause button, a forward button, a backward button, and a mode button. When the forward button is clicked once, the microcontroller 140 processes the control signal from the forward button as a single click on a left key of a mouse (not shown); when the forward button is continuously clicked twice, the microcontroller 140 processes the control signal from the forward button as a double click on the left key of the mouse; when the backward button is clicked once, the microcontroller 140 processes the control signal from the backward button as a single click on a right key of the mouse. Each processing manner can be regarded as an input mapping between the input device 11 (i.e., buttons) and the mouse. In other preferred embodiments, the input device 11 may be represented in other form different from the buttons, accordingly, each operational input on the input device 11 can be processed according to corresponding input mappings between operational input on the input device 11 and operational inputs on the mouse.

Therefore, in the mouse mode, by utilizing the optical sensing module 12, the input device 11, and the input mappings, the portable computing device 1 is operative to serve as a mouse for controlling the computer 1.

In the device mode, the microcontroller 140 controls the optical sensing module 12 to serve as an auxiliary input device for the portable computing device 1 to control a menu (e.g., playlist) displayed on the screen 10. The microcontroller 140 further includes a displacement calculating module 1400 and a menu controlling module 1401. When the portable computing device 1 (e.g., the portable media player) moves along a surface (e.g., a desktop workspace), namely where the displacement calculating module 1400 receives the information of the images captured from the optical sensing module 12, and compares the information of the current image with that of the previous image to obtain the displacement of the movement of the portable computing device 1. The menu controlling module 1401 rotates menu items of the playlist displayed on the screen 10 according to the displacement obtained from the displacement calculating module 1400.

Therefore, in the device mode, by utilizing the optical sensing module 12, a user of the portable computing device 1 can simply move the portable computing device 1 along the surface (e.g., desktop workspace) to rotate the menu (e.g., playlist) displayed, thereby quickly obtaining desired menu items (e.g., list items). In other words, the optical sensing module 12 can be regarded as an auxiliary input device for menu control on the portable computing device 1.

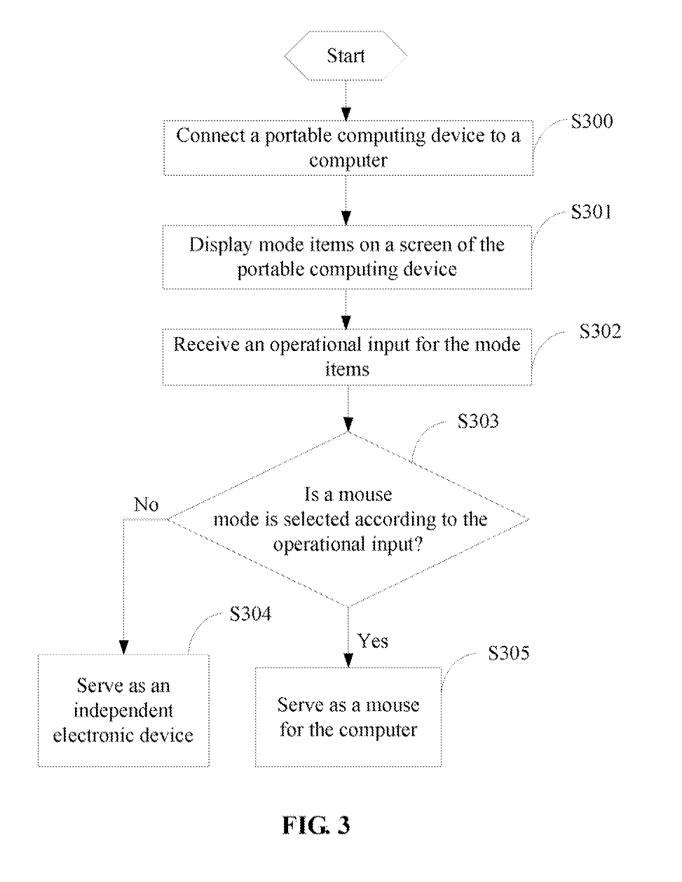

FIG. 3 is a flowchart of a preferred method for enabling the portable computing device 1 of FIG. 2 to enter a particular mode. In step S300, the portable computing device 1 is connected to the computer 2 through the interface 13. In step S301, the microcontroller 140 displays the mode menu including the mouse mode item and the device mode item on the screen 10. In step S302, the microcontroller 140 receives the operational input from the input device 11. In step S303, the microcontroller 140 determines whether the mouse mode item is selected, that is, whether the operational input corresponds to the mouse mode item. If the operational input corresponds to the mouse mode item, in step S305, the microcontroller 140 controls the portable computing device 1 to enter the mouse mode. Otherwise, in step S304, the microcontroller 140 controls the portable computing device 1 to enter the device mode.

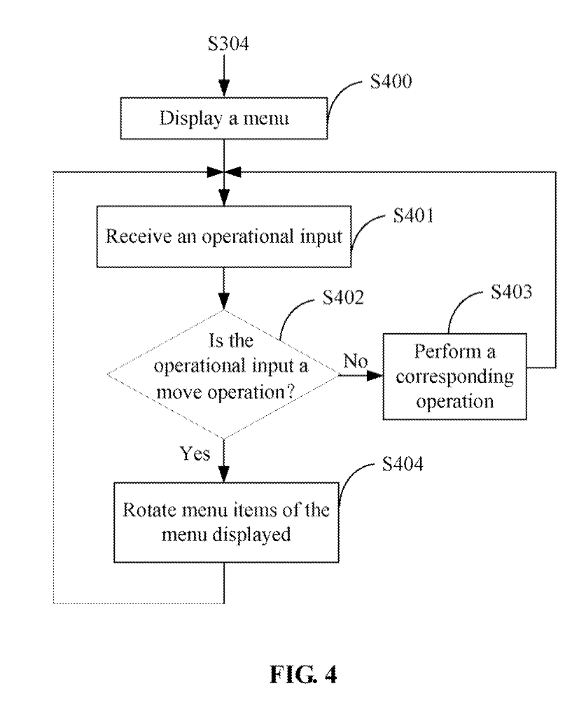

FIG. 4 is a flowchart of a preferred method for controlling the menu displayed on the portable computing device 1 of FIG. 2 in the device mode. In step S400, the screen 10 displays the menu (e.g., playlist). In step S401, the microcontroller 140 receives an operational input from the input device (either the conventional input device 11 or the auxiliary input device 12). In step S402, the microcontroller 140 determines whether the operational input received is a move operation, that is, whether the operational input is from the optical sensing module 12. If the operational input is from the input device 11, in step S403, the microcontroller 140 performs a corresponding function according to the operational input, such as power on, power off, pause, volume adjustment, and the like. If the operational input is from the optical sensing module 12, that is the operational input is a movement of the portable computing device 1, in step S404, the menu controlling module 1401 rotates the menu (e.g., playlist) displayed based on the movement of the media player 1.

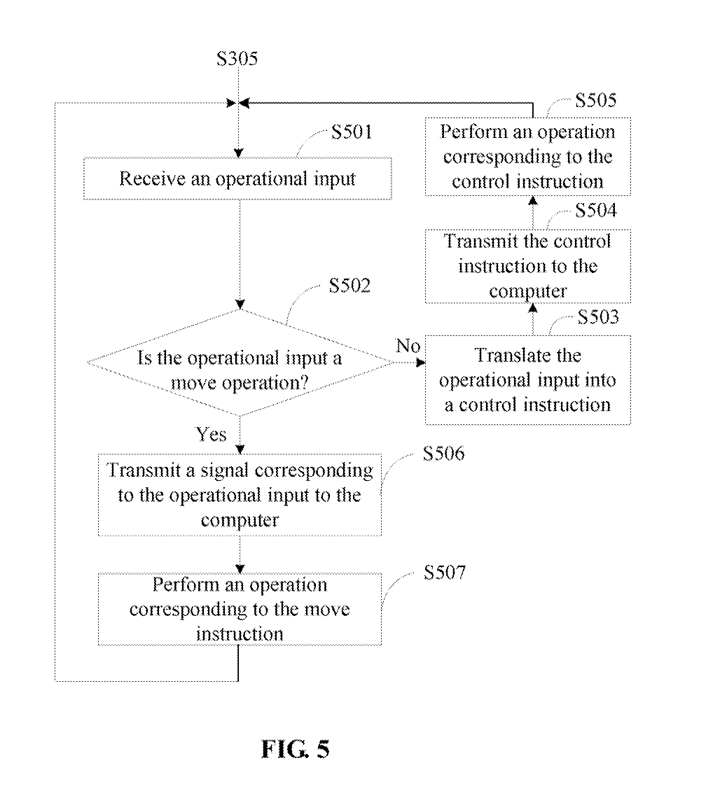

FIG. 5 is a flowchart of a preferred method for controlling the computer 2 by utilizing the portable computing device 1 of FIG. 2 in a mouse mode. In step S501, the microcontroller 140 receives an operational input from the input device (either the input device 11 or the optical sensing module 12). In step S502, the microcontroller 140 determines whether the operational input received is a move operation, that is, whether the operational input received is from the optical sensing module 12.

If the operational input received is from the input device 11, in the S503, the microcontroller 140 translates the control signal corresponding to the operational input into the control instruction according to the input mappings. In step S504, the microcontroller 140 transmits the control instruction to the computer 2 through the interface 13. In step S505, the computer 2 performs the corresponding operation according to the control instruction.

If the operational input received is from the optical sensing module 12, in step S506, the microcontroller 140 transmits the signal corresponding to the operational input to the computer 2 through the interface 13. In step S507, the computer 2 controls the cursor thereof to move a corresponding displacement corresponding to the movement of the portable computing device 1.

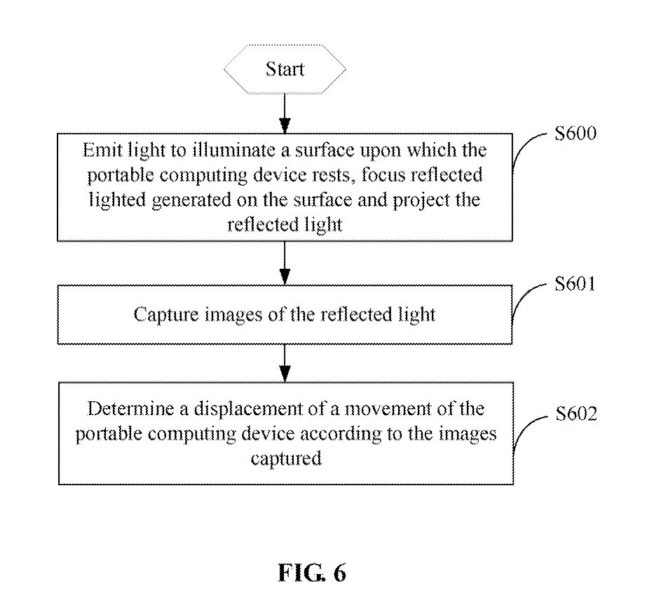

FIG. 6 is a flowchart of a preferred method for generating a move operation for either FIG. 4 or FIG. 5. In step S600, the lighting unit (e.g., LED) 120 emits light to illuminate the surface upon which the portable computing device 1 rests, and the optical lens 121 focuses the reflected light generated on the surface and projects the reflected light on the optical sensor 122. In step S601, the optical sensor 122 periodically captures the images of the reflected light and transmits the information of the images captured to the displacement calculating module 1400. In step S602, the displacement calculating module 1400 compares the information of the current image with that of the previous image to obtain the displacement of the movement of the portable computing device 1.

Although the present invention has been specifically described on the basis of a preferred embodiment and preferred methods thereof, the invention is not to be construed as being limited thereto. Various changes or modifications may be made to the embodiment and method without departing from the scope and spirit of the invention.

What is claimed is:

1. A portable computing device for controlling a computer comprising:
a screen;
an interface configured for communicating with the computer;
an optical sensing module, for capturing images that map a movement of the portable computing device; and
a microcontroller electrically connected to the screen, the interface and the optical sensing module;
wherein the microcontroller displays a menu including a mouse mode item on the screen, when the microcontroller detects the interface is connected to the computer;
the microcontroller controls the portable computing device to enter a mouse mode, when the microcontroller receives an operational input corresponding to the mouse mode item; and
the microcontroller, during the mouse mode, controls the optical sensing module to serve as an input device for the computer to control a movement of a cursor of the computer.

2. The device according to claim 1, wherein the microcontroller, during the mouse mode, generates a signal according to the images captured from the optical sensing module, and transmits the signal to the computer through the interface for controlling the movement of the cursor of the computer.

3. The device according to claim 2, wherein the optical sensing module comprises a lighting unit, an optical lens, and an optical sensor, the lighting unit is for emitting light to illuminate a surface upon which the portable computing device rests, the optical lens is for focusing reflected light generated on the surface and projecting the reflected light on the optical sensor, and the optical sensor is for periodically capturing images of the reflected light and transmitting information of the images captured to the microcontroller.

4. The device according to claim 3, wherein the microcontroller compares the information of a current image with that of a previous image to obtain a displacement of the movement of the portable computing device.

5. The device according to claim 4, wherein the microcontroller generates the signal according to the displacement of the movement of the portable computing device to control the cursor of the computer to move a corresponding displacement.

6. The device according to claim 5, further comprising an input device and a memory, the input device being structured and arranged for receiving an operational input and generating a control signal corresponding to the operational input, and the memory being structured and arranged for storing input mappings for the operational input.

7. The device according to claim 6, wherein the microcontroller, during the mouse mode, translates the control signal into a control instruction according to the input mappings and transmits the control instruction to the computer for performing a corresponding operation through the interface.

8. The device according to claim 6, wherein the menu displayed further comprises a device mode item, the microcontroller controls the portable computing device to enter a device mode when the microcontroller detects an operational input corresponding to the device mode or no operational input corresponding to the items of the menu in a predetermined time period.

9. The device according to claim 8, wherein the microcontroller, during the device mode, rotates a menu displayed on the screen according to the displacement of the movement of the portable computing device.

10. The device according to claim 8, wherein the microcontroller, during the device mode, performs a corresponding operation on the portable computing device in response to the control signal from the input device.

11. The device according to claim 1, wherein the portable computing device is a pocket-sized media player.

12. The device according to claim 9, wherein the menu is a list of media items.
